(19) United States
(12) Patent Application Publication
(10) Pub. No.: US 2018/0350156 A1
(43) Pub. Date: Dec. 6, 2018

(54) THREE-DIMENSIONAL DATA PROCESSING APPARATUS AND THREE-DIMENSIONAL DATA PROCESSING METHOD

(71) Applicant: CANON KABUSHIKI KAISHA, Tokyo (JP)

(72) Inventor: Takenori Tsukikawa, Yokohama-shi (JP)

(21) Appl. No.: 16/101,961

(22) Filed: Aug. 13, 2018

Related U.S. Application Data
(63) Continuation of application No. PCT/JP2017/004721, filed on Feb. 9, 2017.

(30) Foreign Application Priority Data
Feb. 18, 2016 (JP) 2016-028695

(51) Int. Cl. G06T 19/20

(52) U.S. Cl. CPC G06T 19/20; G06T 2200/04; G06T 2200/16

(57) ABSTRACT

A three-dimensional data processing apparatus includes: a request receiving unit configured to receive an editing request including information for specifying an editing target in mesh data; a determining unit configured to determine whether editing restriction information is set in a portion specified as the editing target; an editing unit configured to perform editing processing on the mesh data in accordance with the editing request when the editing restriction information is not set in a portion specified as the editing target; and a notifying unit configured to notify a transmission source of the editing request that the editing of the portion specified as the editing target is restricted when the editing restriction information is set in the portion specified as the editing target.

### CROSS-REFERENCE TO RELATED APPLICATIONS

This application is a Continuation of International Patent Application No. PCT/JP2017/004721, filed Feb. 9, 2017, which claims the benefit of Japanese Patent Application No. 2016-028695, filed Feb. 18, 2016, both of which are hereby incorporated by reference herein in their entirety.

### BACKGROUND OF THE INVENTION

### Field of the Invention

The present invention relates to data representing the shape of a three-dimensional model, and a processing method thereof.

### Description of the Related Art

To represent a three-dimensional model, a method of using mesh constituted of such polygons as triangles and squares is available. A three-dimensional model represented using this method is normally called a polygon, mesh, polygon model and the like. In the following description, data, in which a three-dimensional model is represented by mesh constituted of polygons, is called mesh data.

Mesh data is constituted of a plurality of polygons, and a refined three-dimensional shape can be represented if the size of each constituent polygon is decreased, and an area is represented by a higher number of polygons. However, an increase in a number of polygons to be used increases data volume considerably. Therefore, many computer resources are required to display mesh data representing a refined shape, which slows down the processing. Depending on the computer, it may become difficult to display all mesh data on a screen.

A technique to solve this problem is to decrease data volume by increasing the size of each polygon constituting the data, considering the performance of the apparatus to display the mesh data and the display size of the mesh data. This technique is called “simplification processing”, and is widely used by the general public. However, when the simplification processing is applied to an entire three-dimensional model in the same way, the detailed shape of the three-dimensional model may not be represented.

A technique to solve this problem is to change the degree of simplification between a characteristic portion of the three-dimensional model and other portions, as described in Patent Literature 1. If this technique is used, the representation level of the characteristic portion can be maintained while decreasing the data volume.

### CITATION LIST

### Patent Literature

PTL 1: Japanese Patent Application Publication No. H08-221595

However, the mesh data edited by the method disclosed in PTL 1 does not include information to restrict editing. Therefore, if the mesh data is reedited using another application which does not support the method disclosed in PTL 1, all mesh data is simplified in the same way, regardless the characteristic portion, which negates the effect of using the method disclosed in PTL 1.

As the mesh data formats used by the general public, STL developed by 3D Systems, AMF specified in ISO/ASTM 52915, and 3MF developed by 3MF Consortium are available. However, these file formats do not include information to restrict editing either. Therefore, if mesh data edited by a certain user X using an arbitrary application is edited by another user Y, the user Y can freely edit this mesh data regardless the editing intensions of the user X. If a plurality of users sequentially edit the mesh data in such a state, the final mesh data, after all editing finishes, may not accurately reflect the editing intension of each user.

With the foregoing in view, it is an object of the present invention to provide a technique to prevent the unintended editing of mesh data representing the shape of a three-dimensional model.

### SUMMARY OF THE INVENTION

A first aspect of the present invention provides a three-dimensional data processing apparatus, comprising: an input unit configured to input mesh data representing a shape of a three-dimensional model; a setting unit configured to set editing restriction information, which is information for restricting editing a part of the mesh data; a display unit configured to display an image of the mesh data, in which the editing restriction information is set, on a display device, the display unit displaying a portion of the mesh data in which the editing restriction information is set, using a display format which is different from that used for a portion in which the editing restriction information is not set; a request receiving unit configured to receive an editing request including information for specifying an editing target in the mesh data; a determining unit configured to determine whether the editing restriction information is set in a portion specified as the editing target; an editing unit configured to perform editing processing on the mesh data in accordance with the editing request when the editing restriction information is not set in a portion specified as the editing target; and a notifying unit configured to notify a transmission source of the editing request that the editing of the portion specified as the editing target is restricted when the editing restriction information is set in the portion specified as the editing target.

A second aspect of the present invention provides a three-dimensional data processing apparatus, comprising: an input unit configured to input mesh data added with editing restriction information where editing restriction information, which is information for restricting editing a part of the mesh data representing a shape of a three-dimensional model, is set; a display unit configured to display an image of the mesh data added with editing restriction information, the display unit displaying a portion of the mesh data in which the editing restriction information is set, using a display format which is different from that used for a portion in which the editing restriction information is not set; a request receiving unit configured to receive an editing request including information for specifying an editing target in the mesh data; a determining unit configured to determine whether the editing restriction information is set in a portion specified as the editing target; an editing unit configured to perform editing processing on the mesh data in accordance with the editing request when the editing restriction information is not set in a portion specified as the editing target; and a notifying unit configured to notify a transmission source of the editing request that the editing of the portion specified as the editing target is restricted when the editing restriction information is set in the portion specified as the editing target.

A third aspect of the present invention provides a three-dimensional data processing apparatus, comprising: an input unit configured to input first mesh data, where editing restriction information for restricting editing a part of the mesh data representing a shape of a three-dimensional model is set, and second mesh data generated by editing the first mesh data; a comparing unit configured to compare the first mesh data and the second mesh data, and determine whether the portion of the first mesh data, where the editing restriction information is set, is edited in the second mesh data; and a warning unit configured to output a warning when determination is made that the portion of the first mesh data, where the editing restriction information is set, is edited in the second mesh data.

A fourth aspect of the present invention provides a three-dimensional data processing method, comprising: a step of operating a computer to display an image of mesh data including editing restriction information which is information for restricting editing a part of the mesh data representing a shape of a three-dimensional model, on a display device, a step of operating a computer to receive an editing request including information for specifying an editing target in the mesh data, wherein a computer executes: determining whether the editing restriction information is set in a portion specified as the editing target, performing editing processing on the mesh data in accordance with the editing request when the editing restriction information is not set in a portion specified as the editing target, and notifying a transmission source of the editing request that the editing of the portion specified as the editing target is restricted when the editing restriction information is set in the portion specified as the editing target.

A fifth aspect of the present invention provides a three-dimensional data processing method, comprising: a step of operating a computer to input first mesh data where editing restriction information, which is information for restricting editing a part of the mesh data representing a shape of a three-dimensional model, is set, and second mesh data generated by editing the first mesh data; a step of operating the computer to compare the first mesh data and the second mesh data, and determine whether the portion of the first mesh data where the editing restriction information is set is edited in the second mesh data; and a step of operating the computer to output a warning when determination is made that the portion of the first mesh data, where the editing restriction information is set, is edited in the second mesh data.

A sixth aspect of the present invention provides a non-transitory computer readable storing medium recording a computer program for causing a computer to perform a three-dimensional data processing method comprising: a step of operating a computer to display an image of mesh data including editing restriction information which is information for restricting editing a part of the mesh data representing a shape of a three-dimensional model, on a display device, a step of operating a computer to receive an editing request including information for specifying an editing target in the mesh data, wherein a computer executes: determining whether the editing restriction information is set in a portion specified as the editing target, performing editing processing on the mesh data in accordance with the editing request when the editing restriction information is not set in a portion specified as the editing target, and notifying a transmission source of the editing request that the editing of the portion specified as the editing target is restricted when the editing restriction information is set in the portion specified as the editing target.

Further features of the present invention will become apparent from the following description of exemplary embodiments with reference to the attached drawings.

### BRIEF DESCRIPTION OF THE DRAWINGS

FIG. 1 is a diagram depicting a hardware configuration of a computer;

FIG. 2A is a diagram depicting a configuration of a three-dimensional data processing apparatus according to Embodiment 1, and FIG. 2B is a flow chart depicting an operation of the three-dimensional data processing apparatus;

FIG. 3A to FIG. 3C are diagrams depicting display examples of mesh data according to Embodiment 1;

FIG. 4 is an example of a data structure of mesh data added with editing restriction information;

FIG. 5 is a diagram depicting a configuration of a three-dimensional data processing apparatus according to Embodiment 2;

FIG. 6 is a flow chart depicting an operation of the three-dimensional data processing apparatus according to Embodiment 2;

FIG. 7A and FIG. 7B are diagrams depicting display examples of mesh data according to Embodiment 2;

FIG. 8 is a diagram depicting a configuration of a three-dimensional data processing apparatus according to Embodiment 3;

FIG. 9A and FIG. 9B are flow charts depicting an operation of the three-dimensional data processing apparatus according to Embodiment 3;

FIG. 10A to FIG. 10C are diagrams depicting display examples of mesh data according to Embodiment 3;

FIG. 11A is an example of mesh data before editing, and FIG. 11B is an example of mesh data after editing;

FIG. 12 is a flow chart depicting an operation of the three-dimensional data processing apparatus according to Embodiment 3;

FIG. 13 is a diagram depicting an example of a warning in a mesh data managing application.

### DESCRIPTION OF THE EMBODIMENTS

Preferred embodiments of the present invention will be described in detail with reference to the accompanying drawings.

The configurations described in the following embodiments are merely examples, and the present invention is not limited to the illustrated configurations.

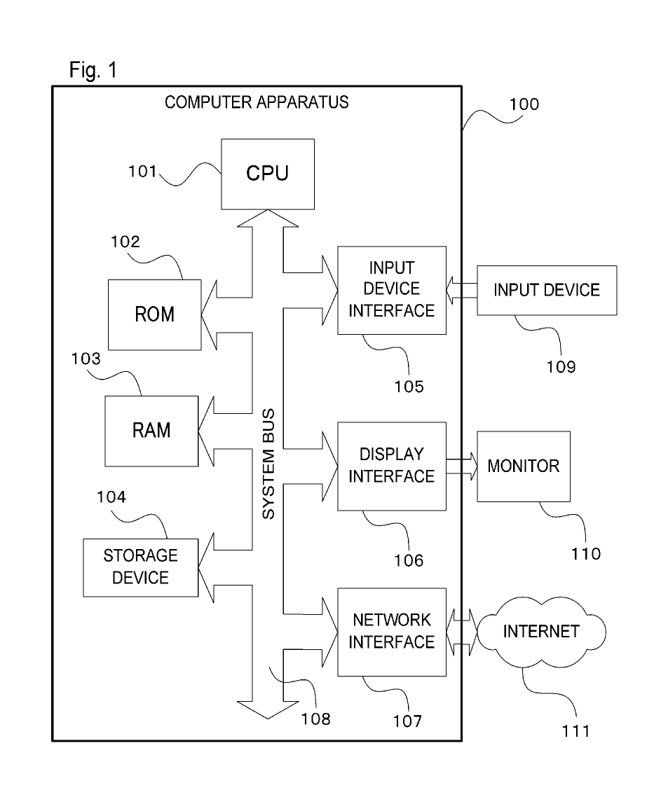

The functions and processing operations described in the following embodiments are implemented by a computer device having the configuration depicted in the block diagram in FIG. 1, for example.

The functions and processing operations of each embodiment may be implemented by a single computer device, or may be implemented by distributed processing using a plurality of computer devices as required. In the case of using a plurality of computer devices, the computer devices may be connected via a Local Area Network (LAN) or the like to be inter-communicable. A part of the functions and processing operations may be implemented by cloud computing.

In FIG. 1, the reference number 101 indicates a central processing unit (CPU) which controls the computer device 100 in general. The reference number 102 indicates a Read Only Memory (ROM) which stores programs and parameters of which updates are unnecessary. The reference number 103 indicates a Random Access Memory (RAM) which temporarily stores programs and data supplied from a storage device 104 or the like. The reference number 104 indicates a storage device installed in the computer device 100, such as a hard disk and a memory card. The storage device 104 may be a device that can be detachably attached to the computer device 100. The storage device 104 includes an optical disk, such as a flexible disk (FD) and a compact disk (CD), a magnetic or optical card, an IC card and memory card. The reference number 105 indicates an interface with an input device 109 (e.g. pointing device, keyboard) which is operated by the user who inputs data. The reference number 106 indicates a display interface with a monitor 110 which displays data held by or supplied by the computer device 100. The reference number 107 indicates a network interface connected to a network line, such as the Internet 111. The reference number 108 is a system bus which communicably connects each unit 101 to 107.

The functions and processing operations described in the following embodiments are implemented by the CPU 101 reading required program codes from the ROM 102 or the storage device 104, and executing the program codes. In this case, the program codes implement the later mentioned functions of the embodiments, hence the program codes, or a storage medium storing the program codes, may be regarded as the present invention. The storage medium for supplying the program codes is, for example, a flexible disk, a hard disk, an optical disk or a magneto-optical disk. Furthermore, as the storage medium, a CD-ROM, a CD-R, a magnetic tape, a non-volatile memory card, a ROM, a DVD, a USB memory, a flash memory or the like may be used.

A part of the later mentioned functions and processing operations of the embodiments may be implemented by an operating system (OS) which runs on the computer. A part of the later mentioned functions and processing operations of the embodiments may be executed by a function extension board embedded in the computer, or a function extension unit connected to the computer. Further, execution of a part of the later mentioned functions and processing operations of the embodiments may be replaced with such as circuit as an ASIC (Application Specific Integrated Circuit).

### Embodiment 1

(Apparatus Configuration)

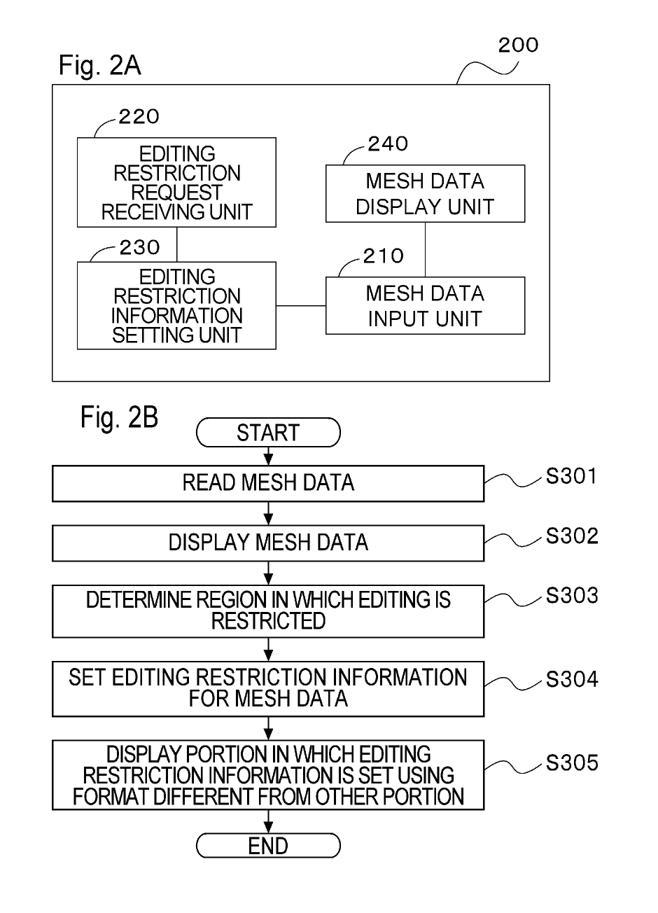

A configuration of a three-dimensional data processing apparatus according to Embodiment 1 of the present invention will be described with reference to FIG. 2A. The three-dimensional data processing apparatus 200 of Embodiment 1 has four functional blocks: a mesh data input unit 210, an editing restriction request receiving unit 220, an editing restriction information setting unit 230, and a mesh data display unit 240.

The mesh data input unit 210 has a function to read mesh data representing the shape of a three-dimensional model from the RAM 103, the storage device 104 or an external storage. Thereby the three-dimensional data processing apparatus 200 can handle a three-dimensional model.

The editing restriction request receiving unit 220 has a function to receive an editing restriction request to restrict editing of the mesh data from the user or an application. The editing restriction request includes information to specify a region of which editing is restricted (hereafter “editing restriction region”) in the mesh data.

The editing restriction information setting unit 230 has a function to set information to restrict editing (hereafter “editing restriction information”) for mesh data read by the mesh data input unit 210, in accordance with the editing restriction request received by the editing restriction request receiving unit 220. Thereby the editing restriction information is set in the mesh data. In this description, mesh data, in which the editing restriction information is set, is called “mesh data added with editing restriction information”.

The mesh data display unit 240 has a function to display an image of the mesh data, which was read by the mesh data input unit 210, on the monitor (display device) 110. The mesh data display unit 240 has a function to display a portion of the mesh data, in which the editing restriction information is set, using a display format that is different from the format used for other portions, based on the editing restriction information which was set by the editing restriction information setting unit 230.

(Setting of Editing Restriction Information)

A processing flow, when the three-dimensional data processing apparatus 200 sets the editing restriction information for mesh data, will be described next with reference to FIG. 2B.

In step S301, the mesh data input unit 210 reads the mesh data. The mesh data to be read may be specified by the user, or may be automatically set by an application. The format of the specified mesh data is not limited. For example, a file, data existing in a memory, a stream output or the like may be specified.

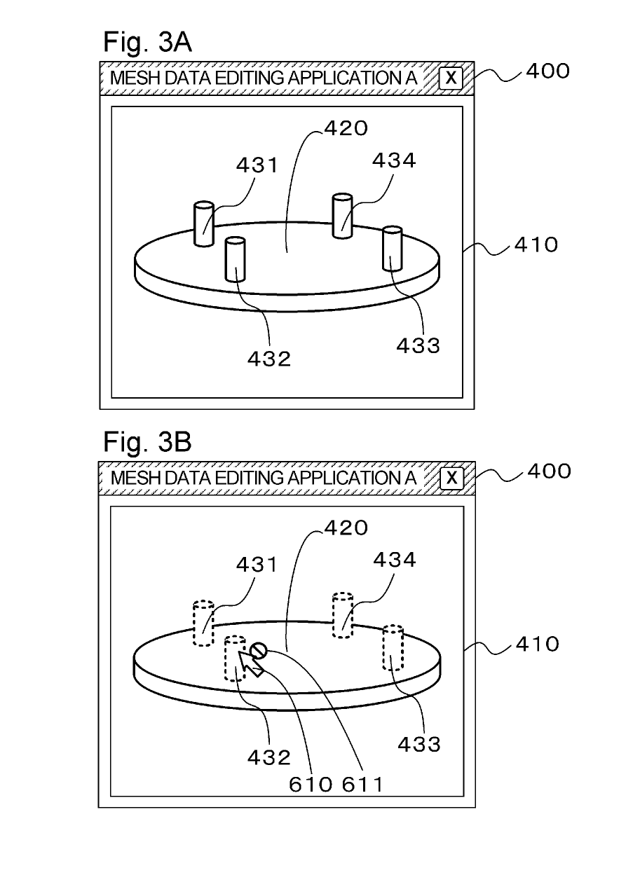

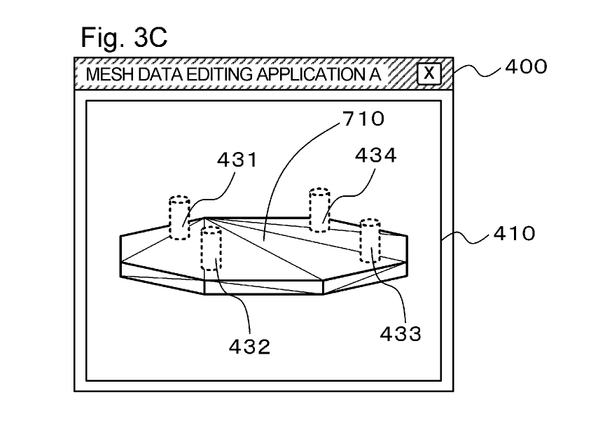

In step S302, the mesh data display unit 240 displays the mesh data, which was read in step S301, on the monitor 110. The display of the mesh data will be described with reference to FIG. 3A.

As an example of displaying mesh data, FIG. 3A indicates a screen of the mesh data editing application A. A mesh data display window 400 is a window having a mesh data display region 410 to display the mesh data. As illustrated in FIG. 3A, an image of the mesh data 420, viewed from a certain view point (perspective view), is displayed in the mesh data display region 410. However, this image viewed from a certain view point is not fixed, but the user or the application may change the view point on the mesh data display region 410 using the input device 109, such as a mouse. The mesh data 420 includes the cylindrical shapes 431, 432, 433 and 434. In an actual screen display, individual polygons constituting the mesh data 420 are displayed, but these polygons are omitted in FIG. 3A since drawing all boundary lines of the polygons in the drawing complicates the drawings, and makes it difficult to describe the display on the screen. This is the same for the other drawings of the present description.

In step S303, the editing restriction request receiving unit 220 receives the editing restriction request instructed by the user or the application. In the case of the user instructing the editing restriction request, the user, for example, performs such operations as range specification and the selection of vertices, sides and surfaces, for the mesh data on the mesh data display unit 240 using the input device 109 such as a mouse, to specify the editing restriction region. In the case of the application instructing the editing restriction request, the application, for example, analyzes the mesh data, extracts a characteristic region, and specifies this extracted characteristic region as the editing restriction region. A region to be extracted as the characteristic region (editing restriction region) differs depending on the purpose and function of the application. For example, in the case of the simplification processing application, a portion in which the shape of the three-dimensional model is complicated (portion in which the shape is extremely detailed), a thin portion or the like, in other words, a portion of which original shape should be maintained (portion which is not simplified), may be extracted as the characteristic region. These instruction methods are merely examples, and a region may be instructed using other methods.

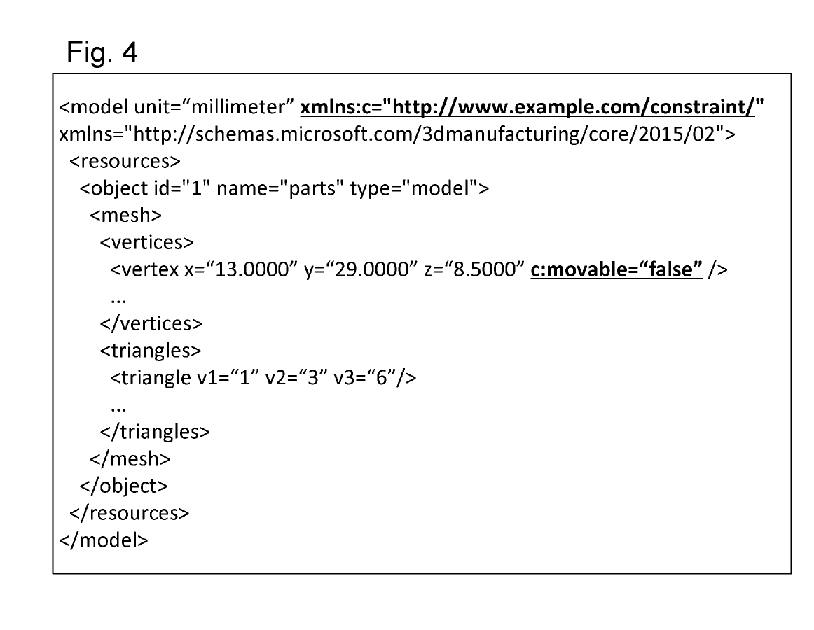

In step S304, the editing restriction information setting unit 230 sets the editing restriction information for the editing restriction region specified in step S303. FIG. 4 is an example of the data structure of the mesh data in which the editing restriction information is set (mesh data added with editing restriction information).

In FIG. 4, the 3MF format is used as the format of the mesh data. The underlined bold portion is a portion generated by extending the 3MF format to set the editing restriction information. In this example, the editing restriction information is expressed using the movable attribute of the <vertex> element which represents each vertex constituting the mesh data. If false is set as a value of the movable attribute, this means that this vertex is not allowed to move. And if the value of the movable attribute is set as true, or if the movable attributes does not exist in the <vertex> element, on the other hand, this means that this vertex is allowed to move. In the case of using the mesh data in this example, in the processing in step S304, the value of the movable attribute is set to false for all the vertices (<vertex> elements) included in the region specified in step S303. In this way, in Embodiment 1, the editing restriction information can be set using the unit of the vertex of the mesh data. This, however, is an example, and the editing restriction information may be set using the unit of the side, the polygon or the point group, side group or polygon group. In other words, the actual method of setting the editing restriction information is not limited as long as the editing restriction information can be set only for a part of the elements of the mesh data, instead of setting the editing restriction information equally for all the mesh data.

The format of the mesh data used in the example in FIG. 4 is 3MF, but the format is not limited to this, and other formats such as STL and AMF may be used. The mesh data in FIG. 4 is text information written in XML format, but when this mesh data is read by a computer, the mesh data is held in the memory as tree structure data having each element and each attribute as a node.

In step S305, in accordance with the editing restriction information which was set in step S304, the mesh data display unit 240 displays the region where the editing restriction information is set (editing restriction region) using a display format that is different from that used for the region where the editing restriction information is not set (non-restriction region). For example, the editing restriction region and the non-restriction region may have different colors filling the regions, different colors of boundary lines of the polygons, or different colors of the vertices, or may have different thicknesses of boundary lines or different sizes of the vertex marks. Further, the editing restriction region and the non-restriction region may have different line types (e.g. solid line, dotted line) in the contours of the regions or boundary lines of the polygons. Furthermore, the editing restriction regions may be display grayed out (displayed by light color or transparent color), blanked or filled in with predetermined patterns or textures. Furthermore, a comment may be attached to the editing restriction region. In other words, any display format may be used as long as the user who views the displayed mesh data can visually distinguish between an editing restriction region and a non-restriction region.

A display example will be described with reference to FIG. 3B. FIG. 3B indicates an example when the mesh data added with editing restriction information is displayed on the mesh data display window 400 of the mesh data editing application A. When the cylindrical shapes 431, 432, 433 and 434 are specified as the editing restriction regions in step S303, the editing restriction information is set for all the vertices included in the cylindrical shapes 431, 432, 433 and 434 in step S304. Then in step S305, the mesh data display unit 240 interprets the editing restriction information, whereby the cylindrical shapes 431, 432, 433 and 434, and the other regions are displayed in different formats. In FIG. 3B, the region where the editing restriction information is set is displayed by dotted lines, and the other regions are displayed by solid lines. Thereby the user can visually identify the portion where editing is restricted. Further, in the mesh data display unit 240 of Embodiment 1, the elements included in a portion where the editing restriction information is set are displayed in an unselectable state when the mesh data is displayed on the mesh data display window 400, so that only elements in which editing restriction information is not set can be selected.

(Editing Restriction Control)

An example in the case of the user or application attempting to edit the mesh data when the portion where the editing restriction information is set is displayed in the unselectable state will be described.

The mesh data editing application A provides the mesh data editing function to the user. For example, the user can operate an input device, such as a mouse, to select the editing target elements (e.g. polygons, vertices, sides) in the mesh data displayed on the mesh data display window 400, and edit the selected editing target elements. The editing processing is, for example, moving coordinates, adding/deleting elements and adding attributes. An element that is displayed in the unselectable state (e.g. element constituting cylindrical shape 432), however, cannot be selected, even if the user moves a cursor 610 onto the position of the element (in this case, an unselectable icon 611 is displayed at the cursor 610 position). By disabling the selection of an element in which the editing restriction information is set as an editing target like this, it can be prevented that the cylindrical shape 432 or the like is edited in error when another user attempts to edit this data using the mesh data editing application A.

An example of a case of performing the mesh data simplification processing by the mesh data editing application A will be described with reference to FIG. 3C. FIG. 3C indicates an example when mesh data, after the simplification processing, is displayed on the mesh data display window 400 on the mesh data editing application A. The mesh data for which the simplification processing is performed is the same as the mesh data indicated in FIG. 3B, where the editing restriction information is set for the cylindrical shapes. In the mesh data display window 400 in FIG. 3C, the mesh data 710, after the mesh data editing application A performed the simplification processing on the mesh data 420, is displayed. The mesh data editing application A interprets the mesh data editing restriction information as indicated in FIG. 4, and does not perform the simplification processing on the cylindrical shapes 431, 432, 433 and 434. Therefore, the portions of the cylindrical shapes included in the mesh data 710 are still represented at high definition, and the other portions are simplified by increasing the sizes of the polygons constituting the mesh data. A bold line indicates the boundary of the three-dimensional model, and a fine line indicates the polygons constituting the three-dimensional model.

Because of this control, if the user or the application sets the editing restrictions in the previous stage, editing of this portion is disabled in the subsequent stage, therefore an unintended editing of the mesh data can be prevented.

In the flow chart in FIG. 2B, the processing operations in steps S304 and S305 are sequentially executed, but an application to perform editing restriction setting processing and an application to display the mesh data may be different. In the case of using different applications, an application in the previous stage performs the editing restriction information setting processing, generates the mesh data added with editing restriction information (see FIG. 4), and stores the data in the storage device or other storage media. Then an application in the subsequent stage causes the mesh data input unit 210 to read the mesh data added with editing restriction information, and the mesh data display unit 240 to perform the display processing in step S305.

According to the above mentioned configuration of Embodiment 1, editing restriction processing can be performed on a part of the mesh data. Further, when the mesh data is displayed, the display format of the portion in which editing is restricted is different from the other portions, hence the user can easily distinguish between the portion where editing is possible and the portion where editing is disabled, and unintended editing can be prevented. Furthermore, in Embodiment 1, the portion in which editing is restricted is displayed in an unselectable state, hence unintended editing can be prevented with certainty. Moreover, the editing restriction information is set in units of elements constituting the mesh data, hence editing can be restricted for any location or any range in the mesh data.

### Embodiment 2

(Apparatus Configuration)

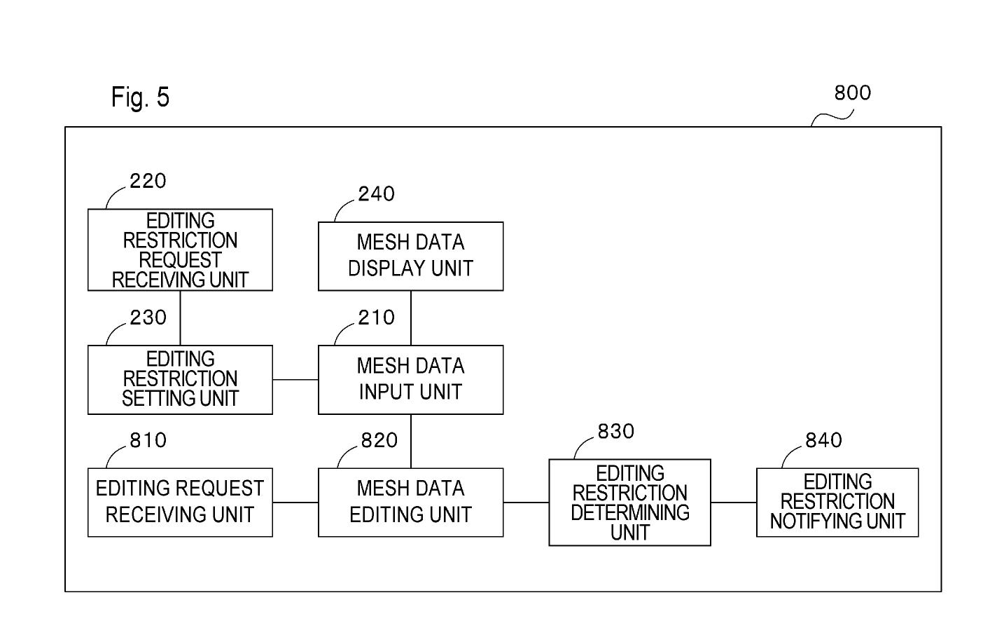

A configuration of a three-dimensional data processing apparatus according to Embodiment 2 will be described with reference to FIG. 5.

The three-dimensional data processing apparatus 800 of Embodiment 2 has an editing request receiving unit 810, a mesh data editing unit 820, an editing restriction determining unit 830, and an editing restriction notifying unit 840, in addition to the configuration of Embodiment 1 illustrated in FIG. 2A. The mesh data input unit 210, the editing restriction request receiving unit 220, the editing restriction information setting unit 230, and the mesh data display unit 240 are basically the same as those described in Embodiment 1.

The editing request receiving unit 810 has a function to receive an editing request for the mesh data from a user or an application. The editing request includes at least editing target information to specify an editing target in the mesh data, and editing content information which represents the content of the editing processing to be performed for the editing target. The editing target may be specified in units of the elements (vertices, sides, polygons) or may be specified in units of the shapes specified by a plurality of elements. The mesh data editing unit 820 has a function to edit the mesh data in accordance with the editing request received by the editing request receiving unit 810. The editing restriction determining unit 830 has a function to determine whether the editing target element is editable based on the editing target information included in the editing request received by the editing request receiving unit 810. If the editing restriction information is set in the editing target element as a result of the determination by the editing restriction determining unit 830, the editing restriction notifying unit 840 notifies the restriction of editing to the transmission source of the editing request (user or application).

(Setting of Editing Restriction Information and Control of Editing Restriction)

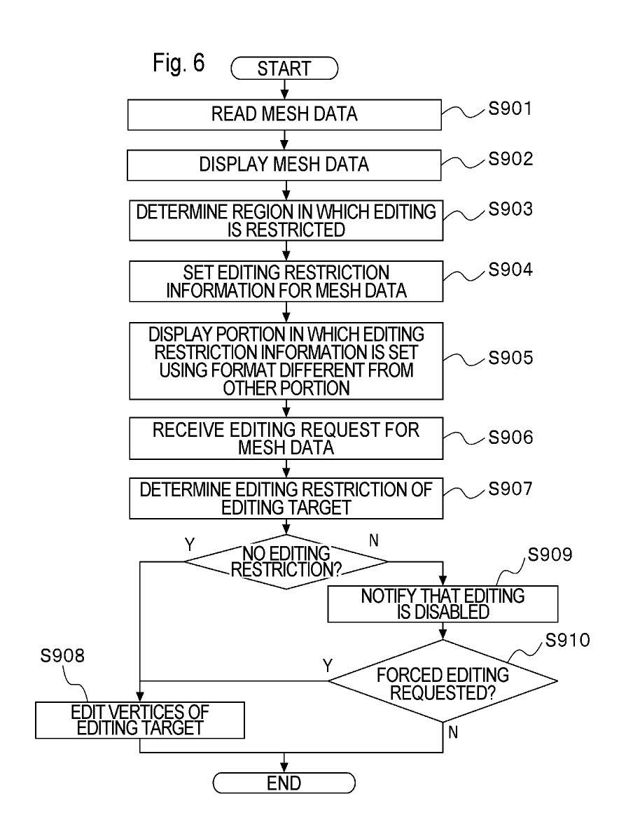

A processing flow of the three-dimensional data processing apparatus 800 will be described with reference to FIG. 6.

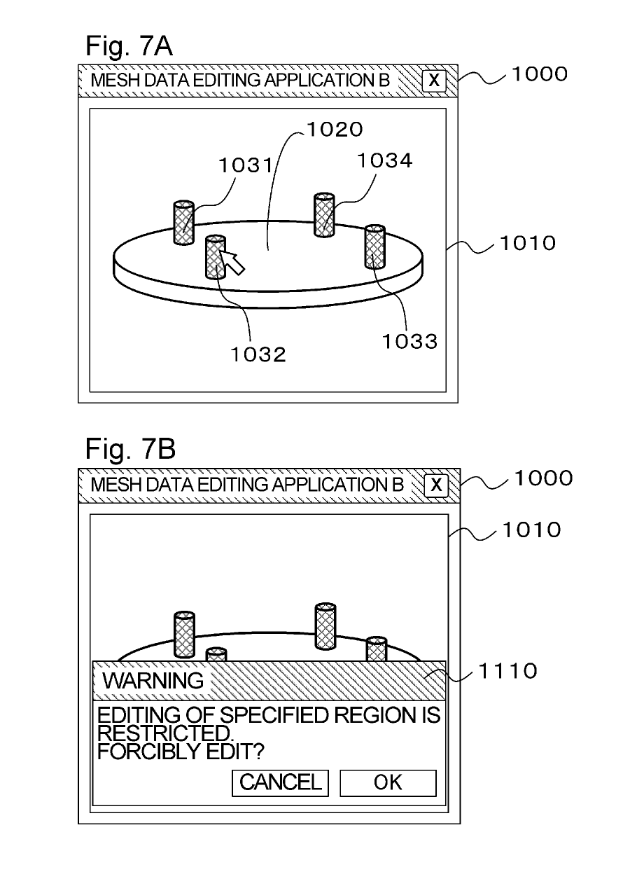

The processing from the reading of the mesh data (step S901) to the setting of the editing restriction information for the mesh data (step S904) are the same as the processing operations of Embodiment 1 (step S301 to step S304 in FIG. 2B). In step S905, according to the editing restriction information that was set in step S904, the mesh data display unit 240 displays the region, in which the editing restriction information is set, using a display format that is different from that used for the other regions. Unlike Embodiment 1, however, even an element, in which the editing restriction information is set, is displayed in a selectable state in Embodiment 2. An example will be described with reference to FIG. 7A.

As an example of displaying the mesh data, FIG. 7A indicates a mesh data editing application B. A mesh data display window 1000 is a window having a mesh data display region 1010 to display the mesh data. In the example in FIG. 7A, mesh data 1020 is displayed in the mesh data display region 1010. The mesh data 1020 includes the cylindrical shapes 1031, 1032, 1033 and 1034. In FIG. 7A, similar to FIG. 3A, polygons constituting the three-dimensional model are omitted.

In the example of FIG. 7A, the cylindrical shapes 1031, 1032 1033 and 1034 are specified in step S903 as the editing restriction regions. Unlike FIG. 3B, the cylindrical shapes 1031, 1032, 1033 and 1034, in which the editing restriction information is set, are displayed filled in with a color that is different from the portions other than the cylindrical shapes. The cylindrical shapes 1031, 1032, 1033 and 1034 are selectable. In this example of the display format for the portions in which the editing restriction information is set, a color that is different from the other portions is filled in, but the display format is not limited to this. The colors of the boundary lines and the vertices of the polygons in the regions in which editing restriction information is set may be changed, or a comment may be displayed in the region.

In step S906, the editing request receiving unit 810 receives the editing request for the mesh data. The editing request is sent from the user or application. For example, the editing request is generated when the user attempts to edit the mesh data by operating the input device 109, such as a mouse, or when the application attempts to perform a certain editing processing on the mesh data.

In step S907, the editing restriction determining unit 830 determines whether the editing target elements are editable based on the editing target information included in the editing request received from step S906. In concrete terms, the editing restriction determining unit 830 determines whether the value of a movable attribute is false or not for all the vertices (<vertex> elements) included in the shape specified as the editing target. As a result of the determination, if a vertex of which movable attribute is false does not exist in the editing target region, the editing restriction determining unit 830 determines that no editing restriction exists, and advances processing to step S908. If there is at least one vertex of which movable attribute is false, on the other hand, the editing restriction determining unit 830 determines that an editing restriction exists, and advances processing to step S909. The editing restriction determining unit 830 performs the above determination processing using the mesh data developed in a tree structure in the memory.

If the editing target is editable, then in step S908, the mesh data editing unit 820 edits the mesh data, which is read in step S901, according to the editing information included in the editing request.

If the editing target is uneditable, then in step S909, the editing restriction notifying unit 840 notifies that the editing target region includes an editing restriction region. If the editing request was received in step S906 based on user operation, the editing restriction notifying unit 840 notifies via a GUI that an editing restriction exists, as indicated in FIG. 7B. In the example in FIG. 7B, the user is notified that an editing restriction exists, using an editing restriction warning dialog 1110. If the application sent an editing request in step S906, then the editing restriction notifying unit 840 notifies the application that the editing restriction exists.

In step S910, the editing restriction notifying unit 840 determines whether the mesh data in which the editing restriction is set is forcibly edited or not. The three-dimensional data processing apparatus 800 of Embodiment 2 allows editing even for mesh data in which the editing restriction is set, and if the source which sent the editing request determines the necessity of forced editing, selects forced editing. This aspect is different from the three-dimensional data processing apparatus 200 described in Embodiment 1, which does not allow any editing at all for the portion of the mesh data where an editing restriction is set. In the case of the example in FIG. 7B, the mesh data editing application B warns the user that an editing restriction is set in the processing in step S909, then allows the user to select whether forced editing is desired. If the application is the source which sent the editing request, the application receives the warning of the editing restriction from the editing restriction notifying unit 840, and the application replies to the editing restriction notifying unit 840 whether the forced editing is desired. If a request for the forced editing is received from the user or application, processing advances to step S908, and if a request for forced editing is not received, processing ends. Thereby even for mesh data in which the editing restriction information is set, editing can be performed if it is determined that editing is absolutely necessary after confirming the warning, which increases the flexibility of editing.

In the flow chart in FIG. 6, the processing operations in steps S905 and S906 are sequentially executed, but the processing operations in and after step S906 may be event-driven type processing operations, which are generated when an editing request for the mesh data is generated. Further, the application for setting the editing restriction and the application for performing the editing processing may be different. In the case when these applications are different, the application in the previous stage sets the editing restriction information, generates the mesh data added with editing restriction information (see FIG. 4), and stores this data in the storage device or storage medium. Then the application in the subsequent stage reads the mesh data added with editing restriction information, and performs the processing in and after step S906.

### Embodiment 3

(Apparatus Configuration)

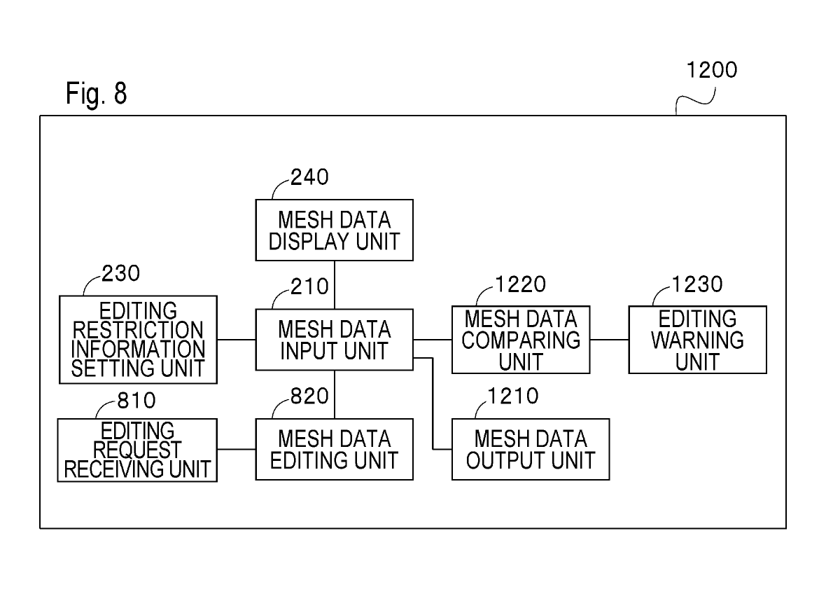

A configuration of a three-dimensional data processing apparatus according to Embodiment 3 will be described with reference to FIG. 8.

The three-dimensional data processing apparatus 1200 of Embodiment 3 has: the configuration of the Embodiment 1 illustrated in FIG. 2A; and the editing request receiving unit 810 and the mesh data editing unit 820 of Embodiment 2 illustrated in FIG. 5. Additionally, the three-dimensional data processing apparatus 1200 includes a mesh data output unit 1210, a mesh data comparing unit 1220, and an editing warning unit 1230. The mesh data input unit 210, the editing restriction request receiving unit 220, the editing restriction information setting unit 230 and the mesh data display unit 240 are basically the same as those described in Embodiment 1. The editing request receiving unit 810 and the mesh data editing unit 820 are also basically the same as those described in Embodiment 2.

The mesh data output unit 1210 has a function to output the mesh data input by the mesh data input unit 210. The mesh data to be output is not limited to the data in which editing restriction information is set by the editing restriction information setting unit 230. Further, the mesh data to be output is not limited to the data edited by the mesh data editing unit 820. The output destination of the mesh data may be arbitrary, such as the memory or storage device in the three-dimensional data processing apparatus 1200, an external apparatus (e.g. computer, data server) and the like. The mesh data comparing unit 1220 has a function to compare two mesh data input by the mesh data input unit 210. The comparison target mesh data may be either mesh data in which editing restriction information is set or mesh data in which editing restriction information is not set. The editing warning unit 1230 has a function to output a warning when the portion, of which editing is restricted, is edited according to the comparison result by the mesh data comparing unit 1220.

(Detecting Edited Portion)

Processing to compare two mesh data and detect whether the data is edited or not will be described next. In the following description, processing of the three-dimensional data processing apparatus 1200 is controlled by three applications. In the following description, the three applications are assumed to be: the mesh data editing application C, the mesh data editing application D and the mesh data managing application.

The mesh data editing application C includes an editing restriction information setting unit 230, so as to set the editing restriction information in the mesh data or to interpret the editing restriction information that is already set. The mesh data editing application D does not include the editing restriction information setting unit 230, and therefore cannot set the editing restriction information for the mesh data, and cannot interpret the editing information that is already set. The mesh data managing application manages the mesh data which was processing by the mesh data editing application C, the mesh data editing application D or the like.

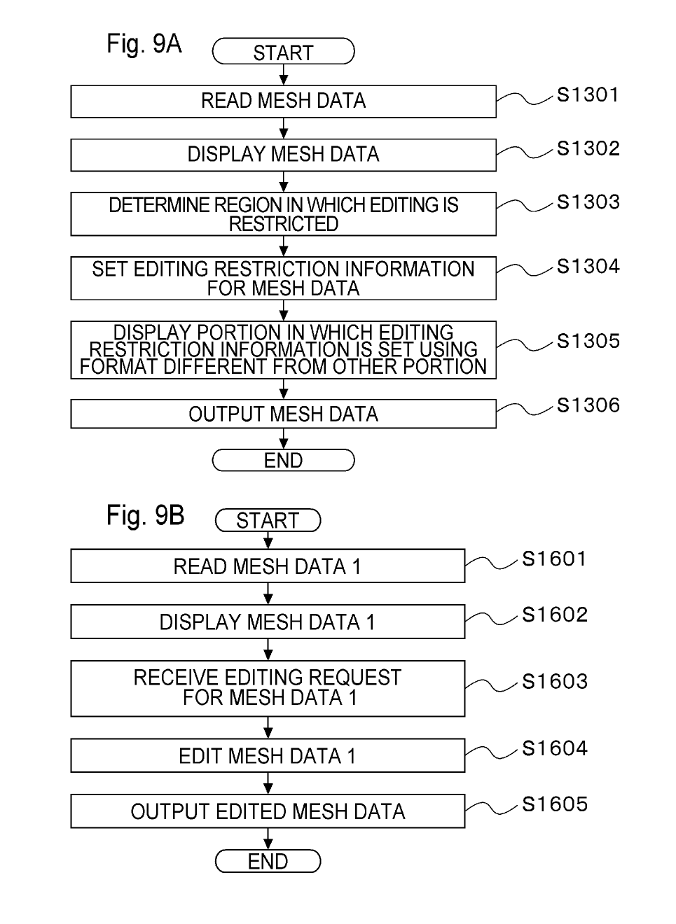

First, the processing flow to set the editing restriction information for the mesh data using the mesh data editing application C will be described with reference to FIG. 9A. The processing operations from reading the mesh data (step S1301) to setting the editing restriction information for the mesh data (step S1304) are the same as the processing operations in Embodiment 1 (step S301 to step S304 in FIG. 2B).

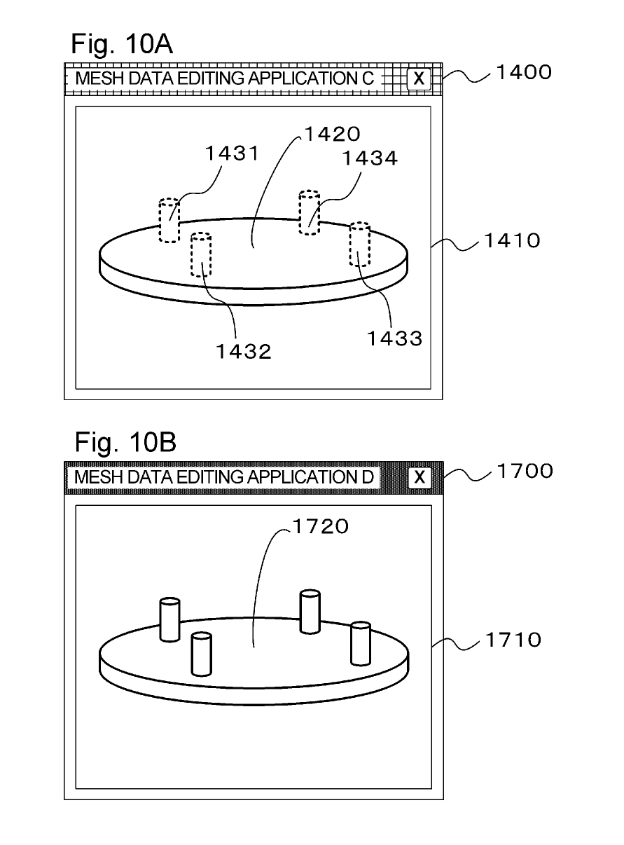

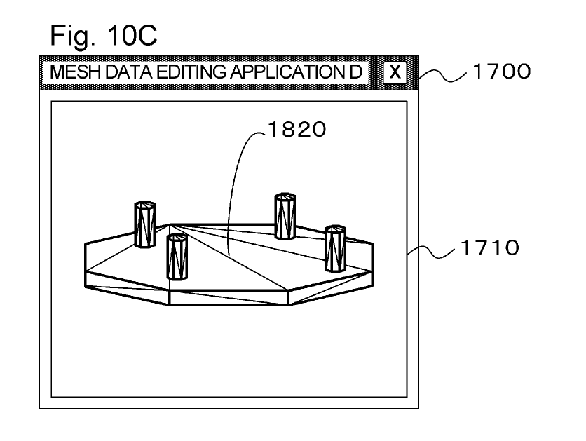

In step S1305, the mesh data display unit 240 displays a region in which the editing restriction information is set using a display format that is different from that used for the other regions, in accordance with the editing restriction information that was set in step S1304. FIG. 10A indicates a display example. Similar to the display example in FIG. 3B, the mesh data display window 1400 of the mesh data editing application C includes a mesh data display region 1410 where the mesh data 1420 is displayed. FIG. 10A is an example when the editing restriction information is set for the cylindrical shapes 1431, 1432, 1433 and 1434 included in the mesh data 1420, and these cylindrical shapes are displayed in a display format that indicates that selection is disabled (e.g. gray out, dotted line).

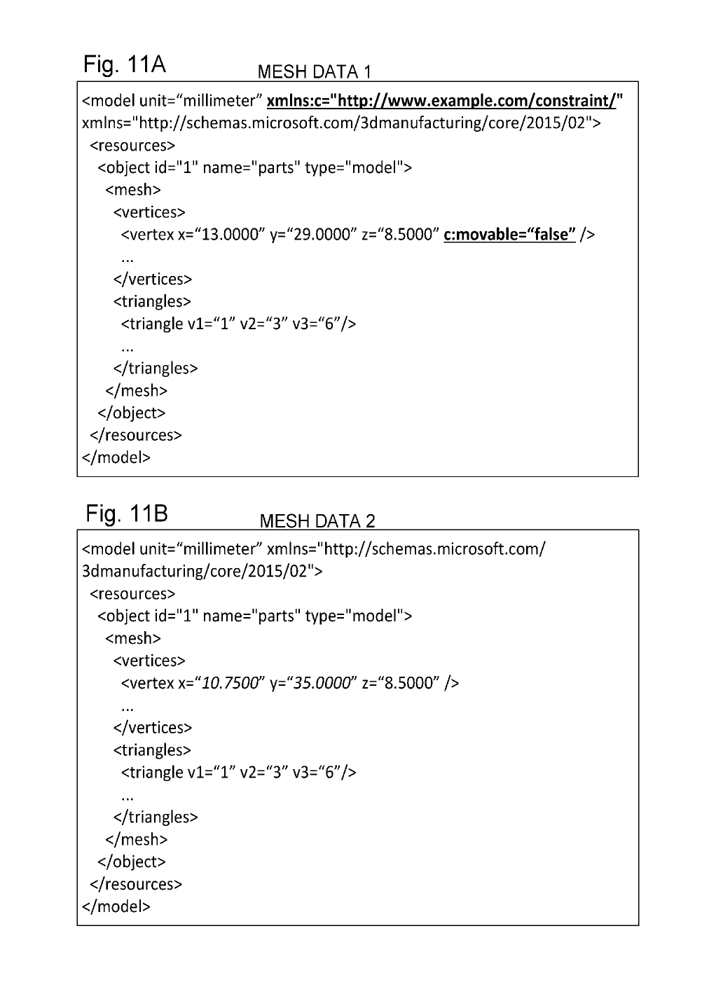

In step S1306, the mesh data output unit 1210 outputs the mesh data in which the editing restriction information is set. The mesh data that is output here is called “mesh data 1” to simplify description. FIG. 11A is an example of the mesh data 1. Similar to the example in FIG. 4, the 3MF format is used as the format of the mesh data. The underlined bold portion is a portion generated by extending the 3MF format to set the editing restriction information. Similar to the example in FIG. 4, the editing restriction information is expressed using the movable attribute of the <vertex> element which represents each vertex constituting the mesh data. If false is set as a value of the movable attribute, this means that this vertex is not allowed to move. And if the value of the movable attribute is true, or if the movable attribute does not exist in the <vertex> element, on the other hand, this means that this vertex is allowed to move. In this example, the format of the mash data is 3MF, but the format is not limited to 3MF, and other formats, such as STL and AMF, may be used. The mesh data in FIG. 11A is text information written in XML format, but when this mesh data is read by the computer, the mesh data is held in the memory as tree structure data having each element and each attribute as a node.

Next the processing flow to edit the mesh data 1 using the mesh data editing application D will be described with reference to FIG. 9B.

In step S1601, the mesh data input unit 210 reads the mesh data 1 in which the editing restriction information is set by the mesh data editing application C.

In step S1602, the mesh data display unit 240 displays the mesh data 1 which was read in step S1601. FIG. 10B indicates a display example. The mesh data display window 1700 of the mesh data editing application D includes a mesh data display region 1710 where the mesh data 1720 is displayed. The editing restriction information was set in the mesh data 1 which is read in step S1601, but the mesh data editing application D is unable to interpret the editing restriction information, hence it is unable to display the mesh data 1 with incorporating the editing restriction information.

In step S1603, the editing request receiving unit 810 receives an editing request for the mesh data. The editing request is sent from the user or the application. For example, the editing request is generated when the user attempts to edit the mesh data by operating the input device 109, such as a mouse, or when the application attempts to perform a certain editing processing on the mesh data.

In step S1604, the mesh data editing unit 820 edits the mesh data 1 which was read in step S1601, in accordance with the editing request which the mesh data editing unit 820 received in step S1603. The mesh data editing application D is unable to interpret the editing restriction information which was set by the mesh data editing application C. Therefore, the mesh data editing application D executes editing even if the editing request received in step S1603 is for the portion of which editing was restricted by the mesh data editing application C. FIG. 10C indicates a display example after editing. In the mesh data display window 1700 of the mesh data editing application D, the mesh data 1820 is displayed in the mesh data display region 1710. The mesh data 1820 is the data generated by editing the mesh data 1720. The example in FIG. 10C is an example of editing when the mesh data simplification processing is performed for the entire mesh data. Similar to the case of displaying in step S1602, the mesh data editing application D is unable to interpret the editing restriction information, hence the simplification processing is performed regardless the editing restriction information.

In step S1605, the mesh data output unit 1210 outputs the mesh data edited in step S1604. Since the mesh data editing application D is unable to output the editing restriction information, the mesh data without the editing restriction information is output even if the editing restriction information is set in the mesh data 1 which was read. The mesh data that is output here is called “mesh data 2” to simplify description. FIG. 11B is an example of the mesh data 2. Similar to the examples in FIG. 4 and FIG. 11A, the 3MF format is used as the format of the mesh data. The mesh data in FIG. 11B is text information written in XML format, but when this mesh data is read by the computer, the mesh data is held in the memory as tree structure data having each element and each attribute as a node. The italic portion is a portion indicating the edited result. The mesh data 2, generated by reading and editing the mesh data 1 indicated in FIG. 11A using the mesh data editing application D, does not include any editing restriction information. In the example in FIG. 11B, editing was performed for the vertices for which the editing restriction information was set in FIG. 11A.

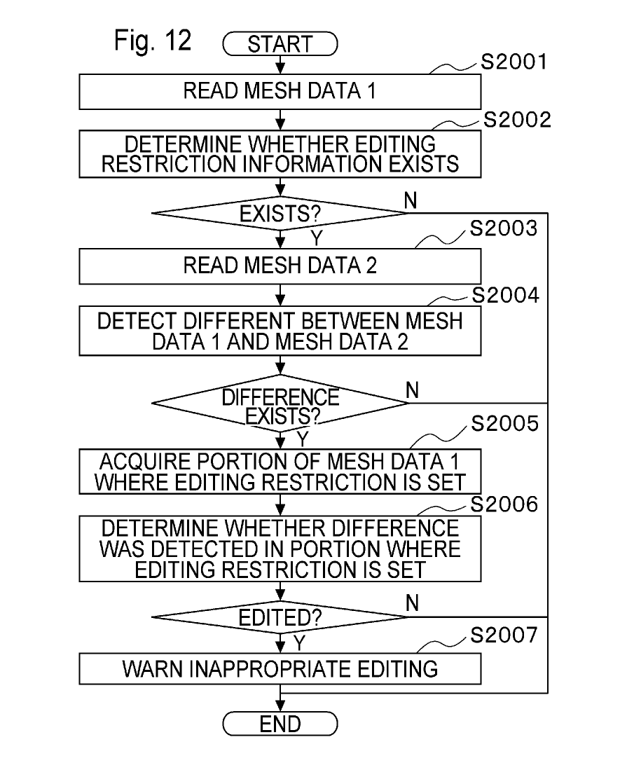

Next a processing flow, to verify whether inappropriate editing (unintended editing) was not performed, by comparing the mesh data before and after editing using the mesh data managing application, will be described with reference to the flow chart in FIG. 12.

In step S2001, the mesh data input unit 210 reads the mesh data 1. In step S2002, the editing restriction information setting unit 230 determines whether the editing restriction information exists in the mesh data 1 which was read in step S2001. If the editing restriction information exists as a result of the determination, processing advances to step S2003, and if not, processing ends.

In step S2003, the mesh data input unit 210 reads the mesh data 2. In step S2004, the mesh data comparing unit 1220 compares the mesh data 1 which was read in step S2001 and the mesh data 2 which was read in step S2003, and detects a difference. If a difference is detected, processing advances to step S2005, and if a difference is not detected, processing ends.

In step S2005, the mesh data comparing unit 1220 acquires a portion where the editing restriction information, included in the mesh data 1, is set. In step S2006, the mesh data comparing unit 1220 determines whether the portion where the editing restriction information is set, which was acquired in step S2005, overlaps with the portion where the difference is generated, which was detected in step S2004. If an overlap exists as a result of the determination, processing advances to step S2007, and if no overlap exists, processing ends.

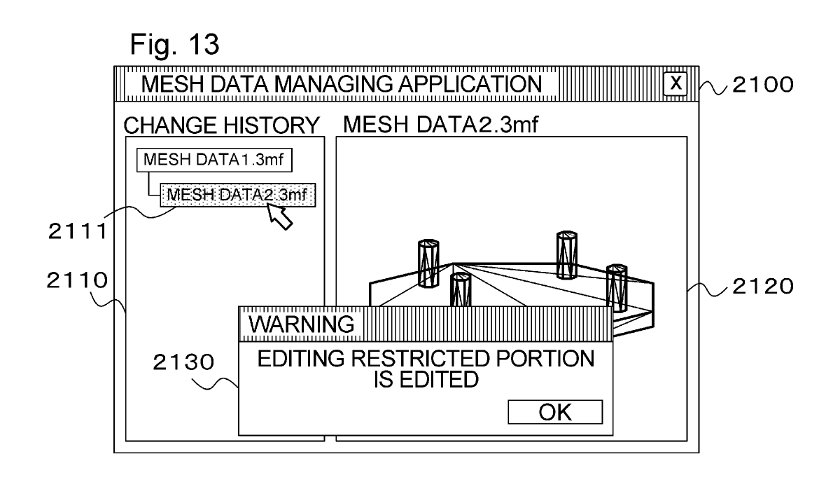

In step S2007, the editing warning unit 1230 outputs a warning that inappropriate editing was performed on the mesh data 1, ignoring the editing restriction. A display example will be described with reference to FIG. 13. In FIG. 13, the window 2100 of the mesh data managing application has a change history display region 2110 to display the change history of the mesh data, and a mesh data display region 2120. In the example in FIG. 13, the information that the mesh data 2 was generated based on the mesh data 1 is displayed in the change history display region 2110. The example in FIG. 13 indicates a state where an object 2111, representing the mesh data 2 included in the change history display region 2110, is selected by the user, and the mesh data 2 is displayed in the mesh data display region 2120. If the processing described in FIG. 12 is performed in this state, an inappropriate editing warning dialog 2130 is displayed. In Embodiment 3, the files output by a plurality of applications are used, but the processing target is not limited to a file. The result of editing is not necessarily output to a file, and may be sent to an application running on another computer via a network, for example.

As mentioned above, even when the editing restriction information is set, editing is allowed if the application to edit the data is unable to interpret the editing restriction information. In Embodiment 3, however, the mesh data before editing in which the editing restriction information is set and the mesh data after the editing in which the editing restriction information is lost are compared, so that whether the mesh data was edited or not is detected. Thereby the user can recognize the unintended editing at an early stage.

In Embodiment 3, the simplification processing was described as the editing processing, but the editing processing is not limited to the simplification processing, and may be manual editing by the user, for example.

### Other Embodiments

Embodiments were described above, but the present invention may be implemented as a system, apparatus, method, program, recording medium (storage medium) or the like. In concrete terms, the present invention may be applied to a system constituted of a plurality of apparatuses (e.g. host computer, interface apparatus, imaging apparatus, web application) or may be applied to a standalone apparatus.

Needless to say, the object of the present invention is achieved by the following. That is, a recording medium (or storage medium) recording software-based program codes (computer program), to implement the above mentioned functions of the embodiments, is supplied to the system or the apparatus. This storage medium is a computer-readable storage medium. Then the computer (or CPU or MPU) of this system or apparatus reads and executes the program codes stored in the storage medium. In this case, the program codes read from the storage medium implement the above mentioned functions of the embodiments, and the storage medium storing the program codes is regarded as a part of the present invention.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention having the above configuration, the unintended editing of mesh data representing the shape of a three-dimensional model can be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A three-dimensional data processing apparatus, comprising:
an input unit configured to input mesh data representing a shape of a three-dimensional model;
a setting unit configured to set editing restriction information, which is information for restricting editing a part of the mesh data;
a display unit configured to display an image of the mesh data, in which the editing restriction information is set, on a display device, the display unit displaying a portion of the mesh data in which the editing restriction information is set, using a display format which is different from that used for a portion in which the editing restriction information is not set;
a request receiving unit configured to receive an editing request including information for specifying an editing target in the mesh data;
a determining unit configured to determine whether the editing restriction information is set in a portion specified as the editing target;
an editing unit configured to perform editing processing on the mesh data in accordance with the editing request when the editing restriction information is not set in a portion specified as the editing target; and
a notifying unit configured to notify a transmission source of the editing request that the editing of the portion specified as the editing target is restricted when the editing restriction information is set in the portion specified as the editing target.

2. A three-dimensional data processing apparatus, comprising:
an input unit configured to input mesh data added with editing restriction information where editing restriction information, which is information for restricting editing a part of the mesh data representing a shape of a three-dimensional model, is set;
a display unit configured to display an image of the mesh data added with editing restriction information, the display unit displaying a portion of the mesh data in which the editing restriction information is set, using a display format which is different from that used for a portion in which the editing restriction information is not set;
a request receiving unit configured to receive an editing request including information for specifying an editing target in the mesh data;
a determining unit configured to determine whether the editing restriction information is set in a portion specified as the editing target;
an editing unit configured to perform editing processing on the mesh data in accordance with the editing request when the editing restriction information is not set in a portion specified as the editing target; and
a notifying unit configured to notify a transmission source of the editing request that the editing of the portion specified as the editing target is restricted when the editing restriction information is set in the portion specified as the editing target.

3. The three-dimensional data processing apparatus according to claim 1, wherein
the display unit displays the portion of the mesh data, in which the editing restriction information is set, in an unselectable state in which the user is unable to select the portion as the editing target.

4. The three-dimensional data processing apparatus according to claim 1, wherein
the editing unit performs the editing processing on the mesh data in accordance with the editing request in a case when the editing restriction information is set in the portion specified as the editing target, and when a request to forcibly edit the specified portion is received from the transmission source of the editing request after the notifying unit has notified that the editing of the portion specified as the editing target is restricted.

5. The three-dimensional data processing apparatus according to claim 2, wherein
the editing unit performs the editing processing on the mesh data in accordance with the editing request in a case when the editing restriction information is set in the portion specified as the editing target, and when a request to forcibly edit the specified portion is received from the transmission source of the editing request after the notifying unit has notified that the editing of the portion specified as the editing target is restricted.

6. A three-dimensional data processing apparatus, comprising:
an input unit configured to input first mesh data, where editing restriction information for restricting editing a part of the mesh data representing a shape of a three-dimensional model is set, and second mesh data generated by editing the first mesh data;
a comparing unit configured to compare the first mesh data and the second mesh data, and determine whether the portion of the first mesh data, where the editing restriction information is set, is edited in the second mesh data; and
a warning unit configured to output a warning when determination is made that the portion of the first mesh data, where the editing restriction information is set, is edited in the second mesh data.

7. The three-dimensional data processing apparatus according to claim 1, wherein
the editing restriction information is set in units of elements constituting the mesh data.

8. A three-dimensional data processing method, comprising:
a step of operating a computer to display an image of mesh data including editing restriction information which is information for restricting editing a part of the mesh data representing a shape of a three-dimensional model, on a display device,
a step of operating a computer to receive an editing request including information for specifying an editing target in the mesh data, wherein
a computer executes:
determining whether the editing restriction information is set in a portion specified as the editing target,
performing editing processing on the mesh data in accordance with the editing request when the editing restriction information is not set in a portion specified as the editing target, and
notifying a transmission source of the editing request that the editing of the portion specified as the editing target is restricted when the editing restriction information is set in the portion specified as the editing target.

9. A three-dimensional data processing method, comprising:
a step of operating a computer to input first mesh data where editing restriction information, which is information for restricting editing a part of the mesh data representing a shape of a three-dimensional model, is set, and second mesh data generated by editing the first mesh data;
a step of operating the computer to compare the first mesh data and the second mesh data, and determine whether the portion of the first mesh data where the editing restriction information is set is edited in the second mesh data; and
a step of operating the computer to output a warning when determination is made that the portion of the first mesh data, where the editing restriction information is set, is edited in the second mesh data.

10. A non-transitory computer readable storing medium recording a computer program for causing a computer to perform a three-dimensional data processing method comprising:
a step of operating a computer to display an image of mesh data including editing restriction information which is information for restricting editing a part of the mesh data representing a shape of a three-dimensional model, on a display device,
a step of operating a computer to receive an editing request including information for specifying an editing target in the mesh data, wherein
a computer executes:
determining whether the editing restriction information is set in a portion specified as the editing target,
performing editing processing on the mesh data in accordance with the editing request when the editing restriction information is not set in a portion specified as the editing target, and
notifying a transmission source of the editing request that the editing of the portion specified as the editing target is restricted when the editing restriction information is set in the portion specified as the editing target.
